(19) United States
(12) Patent Application Publication
(10) Pub. No.: US 2026/0315306 A1
(43) Pub. Date: Oct. 15, 2026

(54) FALL PREVENTION SUPPORT SYSTEM FOR ASSISTED AMBULATION AND STABILITY ENHANCEMENT

(71) Applicant: Fall Prevention Strategies, LLC, Mt. Kisco, NY (US)

(72) Inventor: Leon B. Kassman, Mt. Kisco, NY (US)

(21) Appl. No.: 19/697,866

(22) Filed: Jun. 4, 2026

Related U.S. Application Data
(60) Provisional application No. 63/834,697, filed on Apr. 14, 2025.

(51) Int. Cl. A61H 3/00

(52) U.S. Cl. CPC A61H 3/008; A61H 2201/018; A61H 2201/1207; A61H 2201/14; A61H 2201/1635; A61H 2201/165; A61H 2201/5025

(57) ABSTRACT

A fall prevention support system, assistive mobility and stabilization system, and fall-prevention mobility assistance system for assisted ambulation and stability enhancement are disclosed. The system includes an elongated magnetic support assembly configured for attachment to a ceiling, wall, or other architectural support structure and a wearable lanyard assembly configured for magnetically assisted user movement and stabilization. The elongated magnetic support assembly and the wearable lanyard assembly are magnetically coupled to generate a magnetic attraction force sufficient to provide user support, stabilization, guided movement assistance, fall-resistance assistance, rehabilitation assistance, or combinations thereof during user ambulation. The system may further include movement interfaces, rolling carriage assemblies, magnetic interaction components, pressure-sensitive safety mechanisms, portable power sources, and guided mobility pathways configured to facilitate assisted user movement.

### TECHNICAL FIELD

The present disclosure relates to fall prevention and mobility assistance systems and, more particularly, to overhead-supported stabilization systems configured to assist user ambulation and reduce the likelihood of falls within residential, medical, commercial, and institutional environments.

### BACKGROUND

Falls are a major source of injury, disability, and loss of independence, particularly among elderly individuals and persons with impaired mobility. Existing approaches to fall management have traditionally focused on post-fall treatment, rehabilitation, or environmental modifications intended to reduce hazards within homes, hospitals, nursing facilities, and other environments. These approaches include walkers, canes, grab bars, handrails, braces, lifts, rehabilitation equipment, and physical therapy devices. However, such systems generally do not provide continuous movement-associated support intended to prevent a fall while a person is actively walking or transitioning between locations.

Various prior art devices have been developed to assist individuals in maintaining balance or stability during movement. One category of such devices is overhead hanging supports, commonly referred to as “straphangers,” which have long been used on moving vehicles such as trains, buses, and streetcars. These devices typically provide a suspended handhold that allows a standing passenger to stabilize themselves while the vehicle is in motion.

U.S. Pat. No. 1,027,705 to Elstroth discloses hanger structures used in construction applications. U.S. Pat. No. 1,067,916 to Hammer discloses a straphanger device incorporating a spring mechanism that reduces the swaying forces experienced by standing passengers in streetcars. U.S. Pat. No. 1,279,073 to Baake discloses a suspended leather support strap terminating in a stirrup-like grip for passenger stabilization. U.S. Pat. No. 3,645,212 to Dahlstrom discloses an overhead support device configured to improve accessibility to hanging support straps for shorter individuals within transportation environments.

Additional prior art includes support bars and grab devices configured to assist users in maintaining balance or stability. Meyer et al. disclosed folding grab bar mechanisms intended to assist with accessibility. More recent developments include support systems employing movable or articulated support members intended to accommodate user movement. Meyer (U.S. Pat. No. 11,589,715B2, 2023) described a movable and foldable support bar arrangement designed to provide adaptive positioning during use.

Other prior art references involve magnetic coupling or locking mechanisms. Jenkins et al. disclosed the use of multiple magnets arranged to create an internal locking force within a support or tethering structure. Such magnetic arrangements have been used in various fastening and retention systems intended to maintain alignment or engagement between movable components. Despite the existence of these various supports, hanging, grab bars, and stabilization devices, there remains a need for systems specifically adapted to provide continuous support to users while moving through residential or institutional environments where falls commonly occur. Existing systems generally do not address the unique requirements of assisting users during ordinary ambulation in homes, apartments, medical facilities, or similar settings.

Accordingly, there is a need for improved fall-prevention and mobility-assistance systems capable of providing continuous user support during ambulation in residential and institutional environments while accommodating ordinary movement and accessibility requirements.

### SUMMARY

The present disclosure relates to overhead-supported stabilization systems configured to assist user ambulation and reduce the likelihood of falls within residential, medical, commercial, and institutional environments.

In an aspect, the present disclosure provides a fall prevention support system for assisted ambulation and stability enhancement, including an elongated magnetic support assembly configured for attachment to a support structure and a wearable lanyard assembly configured for magnetically assisted user movement and stabilization. The elongated magnetic support assembly and the wearable lanyard assembly are magnetically coupled to generate a magnetic attraction force sufficient to provide user support, stabilization, guided movement assistance, fall-resistance assistance, or combinations thereof during user ambulation. An advantage of this aspect is that the system may provide continuous assisted mobility and stabilization while reducing the likelihood of user falls during movement.

In another aspect, the wearable lanyard assembly may include one or more movement interfaces configured to permit relative movement along the elongated magnetic support assembly while maintaining a spaced relationship therebetween through magnetic attraction forces. An advantage of this aspect is that guided movement may be achieved with reduced friction and minimized direct physical contact.

In another aspect, the elongated magnetic support assembly may be mounted to a ceiling, wall, or other architectural support structure. An advantage of this aspect is that the system may be integrated into residential, rehabilitation, medical, or assisted living environments without occupying substantial floor space.

In another aspect, the elongated magnetic support assembly may be embedded within or concealed by a ceiling, wall, molding structure, or architectural enclosure. An advantage of this aspect is that guided mobility assistance may be provided while reducing visual obstruction within an architectural environment.

In another aspect, the system may include one or more magnetic interaction components comprising permanent magnetic elements comprising metallic, ceramic, rare-earth, or composite magnetic materials, or combinations thereof. An advantage of this aspect is that enhanced magnetic attraction forces and long-term operational stability may be achieved.

In another aspect, the system may include a pressure-sensitive safety mechanism configured to detect excess pulling force, hazardous tension, premature release conditions, overload conditions, or combinations thereof and initiate a protective response. An advantage of this aspect is that user safety may be improved during destabilization or fall-related events.

In another aspect, the system may include one or more cylindrical electromagnets configured to generate focused magnetic propulsion and/or stabilization fields for assisted ambulation. An advantage of this aspect is that focused magnetic guidance and improved stabilization assistance may be provided during user movement.

In another aspect, the system may include a stacked magnetic array comprising stacked, interconnected, concentrically arranged, or serially arranged magnetic interaction components configured to increase magnetic field strength. An advantage of this aspect is that magnetic stabilization performance and guided movement assistance may be improved.

In another aspect, the wearable lanyard assembly may include a flexible rotational connector configured to permit rotational, angular, pivoting, twisting, or multidirectional movement substantially approaching 360 degrees. An advantage of this aspect is that user mobility, flexibility, and comfort during operation may be enhanced.

In another aspect, the system may include one or more protective outer coverings surrounding magnetic interaction components. An advantage of this aspect is that component protection, impact resistance, user comfort, and surface wear reduction may be improved.

In another aspect, the wearable lanyard assembly may include a portable power source, including replaceable batteries, rechargeable batteries, or combinations thereof, configured to power one or more magnetic interaction components. An advantage of this aspect is that portable and self-contained system operation may be achieved.

In another aspect, the wearable lanyard assembly may include a rolling carriage assembly configured for guided rolling movement relative to the elongated magnetic support assembly or a guided mobility pathway. An advantage of this aspect is that smooth assisted ambulation and reduced resistance to movement may be achieved.

In another aspect, the system may include an electrical power control switch configured to selectively activate, interrupt, regulate, or control electrical energy supplied to one or more magnetic interaction components. An advantage of this aspect is that operational flexibility and energy management may be improved.

In another aspect, the wearable lanyard assembly may include a hand engagement member and/or a dual-hand stabilization member configured to assist with user stabilization, movement control, rehabilitation, or assisted ambulation. An advantage of this aspect is that user balance, guided support, and rehabilitation assistance may be enhanced.

In another aspect, the elongated magnetic support assembly may define an invisible guided mobility pathway that permits guided user movement without visible rails, suspended cables, or floor-mounted tracks. An advantage of this aspect is that assisted ambulation support may be provided while preserving architectural appearance and open floor access.

In another aspect, the system may provide dynamic magnetic stabilization through an adjustable magnetic field intensity responsive to user movement, instability, rehabilitation requirements, fatigue, environmental conditions, or combinations thereof. An advantage of this aspect is that adaptive stabilization assistance and personalized movement support may be achieved.

In another aspect, the elongated magnetic support assembly may extend continuously through multiple rooms, hallways, stairways, or architectural regions to provide uninterrupted assisted mobility. An advantage of this aspect is that continuous guided ambulation support may be maintained across multiple movement environments.

In another aspect, the wearable lanyard assembly may be guided substantially without direct mechanical attachment to the elongated magnetic support assembly. An advantage of this aspect is that contactless magnetic guidance and reduced mechanical wear may be achieved.

In another aspect, the system may include one or more guide rail structures configured to maintain a spaced relationship between the elongated magnetic support assembly and the wearable lanyard assembly during movement. An advantage of this aspect is that guided movement alignment and movement stability may be improved.

In another aspect, the system may include an emergency signaling system configured to initiate a notification upon detection of excessive pulling force, abrupt release conditions, instability conditions, or combinations thereof. An advantage of this aspect is that emergency response assistance and user safety monitoring may be improved.

In another aspect, the elongated magnetic support assembly may include an elongated electromagnet bar extending along a guided mobility pathway. An advantage of this aspect is that continuous magnetic support and guided ambulation assistance may be maintained throughout a user's movement region.

In another aspect, movement of the wearable lanyard assembly may be assisted through both magnetic attraction forces and mechanical rolling components. An advantage of this aspect is that combined magnetic and mechanical guidance may improve the smoothness of movement and stabilization performance.

In another aspect, the elongated magnetic support assembly may be removably attached to a support structure. An advantage of this aspect is that installation flexibility, maintenance accessibility, and architectural adaptability may be improved.

In another aspect, the disclosed system may be configured for rehabilitation assistance, elderly mobility assistance, disability support, therapeutic movement assistance, or fall prevention applications. An advantage of this aspect is that the system may support a broad range of assisted ambulation and user locomotion assistance environments.

In another aspect, the present disclosure provides a user locomotion assistance system including an elongated magnetic support assembly extending along a user movement pathway and a wearable lanyard assembly magnetically coupled thereto to provide guided movement assistance, stabilization, and fall-resistance support during ambulation. An advantage of this aspect is that guided user movement and stabilization may be continuously maintained throughout a movement environment.

In another aspect, the present disclosure provides a contactless magnetic guidance system comprising a magnetic guidance assembly extending along an architectural support structure and a wearable lanyard assembly configured for magnetic interaction with the magnetic guidance assembly to provide assisted movement and stabilization. An advantage of this aspect is that guided mobility support may be achieved without requiring continuous direct mechanical attachment between interacting components.

### BRIEF DESCRIPTION OF THE FIGURES

The following detailed description of illustrative embodiments is better understood when read in conjunction with the appended drawings. To illustrate the present disclosure, exemplary constructions of the disclosure are shown in the drawings. However, the present disclosure is not limited to a specific device, tool, or instrumentalities disclosed herein. Moreover, those skilled in the art will understand that the drawings are not to scale.

FIG. 1 illustrates a perspective view of a fall prevention support system for assisted ambulation and stability enhancement, in accordance with an embodiment of the present disclosure;

FIG. 2 illustrates a perspective view of the wearable lanyard assembly for use with the fall prevention support system for assisted ambulation and stability enhancement, in accordance with an embodiment of the present disclosure;

FIG. 3 illustrates a perspective view of a lanyard cap sleeve cover assembly for use with the fall prevention support system for assisted ambulation and stability enhancement, in accordance with an embodiment of the present disclosure;

FIG. 4 illustrates a perspective view of an elongated magnetic support assembly for use with the fall prevention support system for assisted ambulation and stability enhancement, in accordance with an embodiment of the present disclosure;

FIG. 5 illustrates a perspective view of a rolling carriage assembly for use with the fall prevention support system for assisted ambulation and stability enhancement, in accordance with an embodiment of the present disclosure;

FIG. 6 illustrates a perspective view of a heavy-duty rolling carriage assembly for use with the fall prevention support system for assisted ambulation and stability enhancement, in accordance with an embodiment of the present disclosure;

FIG. 7 illustrates a perspective view of a support mounting assembly for use with the fall prevention support system for assisted ambulation and stability enhancement, in accordance with an embodiment of the present disclosure;

FIG. 8 illustrates a perspective view of an edge-track support assembly for use with the fall prevention support system for assisted ambulation and stability enhancement, in accordance with an embodiment of the present disclosure; and

FIG. 9 illustrates a perspective view of a stairway guided mobility pathway assembly for use with the fall prevention support system for assisted ambulation and stability enhancement, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are outlined to provide a thorough understanding of the present disclosure. It will be apparent, however, to one skilled in the art that the present disclosure can be practiced without these specific details. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described, which may apply to some embodiments but not to others.

Moreover, although the following description contains many specifics for illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

An “elongated magnetic support assembly” refers to any extended structure configured to generate, support, or guide magnetic forces along a pathway for assisting user movement, stabilization, positioning, or rehabilitation. The assembly may be mounted to, embedded within, suspended from, or concealed inside architectural structures, including ceilings, walls, molding, frames, or support surfaces. Examples include an alectromagnet Bar, a ceiling-mounted magnetic rail, a concealed wall magnetic strip, a tubular magnetic guide, or a curved magnetic pathway.

A “wearable lanyard assembly” refers to any user-worn support device configured to connect a user to a magnetic guidance, stabilization, or mobility assistance system. The assembly may support one or more arms, shoulders, torso regions, or other body portions and may include straps, harnesses, rings, grips, connectors, or support members. Examples include Lanyard system, arm-support lanyards, rehabilitation harnesses, stabilization straps, or wearable support tether systems.

A “magnetic interaction component” refers to any magnetic, electromagnetic, magnetizable, or ferromagnetic element configured to create, modify, strengthen, direct, or respond to magnetic forces within the system. Such components may operate independently or cooperatively with other magnetic elements. Examples include electromagnets, permanent magnets, ceramic magnets, rare-earth magnets, metal attraction plates, or magnetic coupling structures.

A “movement interface” refers to any component configured to facilitate movement, rolling, sliding, hovering, gliding, levitation, or guided travel relative to another structure or pathway. The movement interface may operate through physical contact, magnetic attraction, or substantially contactless guidance. Examples include wheels on a Lanyard Cap, rolling interfaces, sliding assemblies, floating magnetic movement members, or guided trolley structures.

A “rolling carriage assembly” refers to a movable support structure including wheels, bearings, rollers, or similar motion mechanisms configured to travel along, adjacent to, or beneath a support assembly. The rolling carriage assembly may be magnetically guided or mechanically assisted. Examples include Ball-Bearing Trolley Lanyards, wheel carriages, roller trolleys, guided rolling platforms, or magnetic trolley assemblies.

A “contactless guidance interface” refers to a system or component configured to guide, position, stabilize, or support movement through magnetic force without requiring continuous direct physical contact between interacting structures. The interface may maintain a spaced relationship through magnetic attraction or repulsion. Examples include floating wheel systems, magnetic levitation guides, hovering lanyard movement systems, or non-contact trolley arrangements.

A “flexible rotational connector” refers to a coupling structure configured to permit rotational, angular, pivoting, twisting, or multidirectional movement between connected components while maintaining mechanical connection. Examples include interconnecting wire-ropes, flexible cable connectors, swivel tethers, rotational linkage members, or articulated connection assemblies.

A “protective outer covering” refers to any coating, padding, enclosure, housing, sleeve, or protective material configured to shield magnetic or mechanical components from damage, impact, wear, contamination, or user contact. Examples include soft magnet coverings, rubber sleeves, foam protective housings, padded enclosures, or resilient protective coatings.

A “portable power source” refers to any removable, replaceable, rechargeable, or self-contained energy supply configured to provide electrical power to magnetic, electronic, sensing, or control components within the system. Examples include AA battery compartments, rechargeable battery packs, lithium-ion power modules, standby battery systems, or portable electrical energy units.

An “electrical power control switch” refers to any manually or automatically operated mechanism configured to selectively activate, interrupt, regulate, or control electrical power supplied to one or more system components. Examples include on/off switches, push-button activation controls, toggle switches, electronic power regulators, or magnetic activation controls.

A “pressure-sensitive safety mechanism” is a device configured to detect force, tension, pressure, overload conditions, excessive pulling, release conditions, or hazardous operating states, and to initiate a protective response. The response may include reducing magnetic force, interrupting power, releasing support tension, or activating alerts. Examples include excess-pull switches, premature-release pressure switches, overload sensors, or emergency-release detectors.

A “hand engagement member” refers to any handheld, graspable, or user-contact structure configured to assist stabilization, balance, support, rehabilitation, or movement control. Examples include metal hand rings, plastic grip rings, stabilization handles, grasping loops, or user grip members.

A “dual-hand stabilization member” refers to an elongated handheld structure configured to be grasped by one or both hands to provide support, stabilization, movement assistance, exercise functionality, or rehabilitation assistance. Examples include an 8-inch double-handed wand, stabilization bars, support rods, rehabilitation grip wands, or elongated grip members.

A “guided mobility pathway” refers to a predefined route, region, directional system, or movement corridor configured to guide, stabilize, or assist user movement through magnetic interaction or controlled positioning. The pathway may be visible or concealed within architectural structures. Examples include magnetic walking paths, invisible mobility corridors, ceiling magnetic routes, or rehabilitation movement pathways.

A “contactless magnetic guidance system” is a movement-guidance arrangement that uses magnetic fields to direct, stabilize, support, position, or guide components without continuous mechanical attachment or direct physical contact. Examples include floating magnetic support systems, magnetic levitation guides, hover-assisted movement systems, or non-contact magnetic pathways. “Dynamic magnetic stabilization” refers to the active adjustment, modulation, or control of magnetic forces in response to user movement, gait, instability, fatigue, rehabilitation requirements, environmental conditions, or detected hazards. Examples include adaptive magnetic support systems, smart stabilization controls, variable magnetic assistance systems, or automatic balance-correction systems.

A “wearable support apparatus” refers to any device worn by a user and configured to provide physical support, movement assistance, stabilization, rehabilitation assistance, balance improvement, or guided mobility. Examples include Lanyard systems, arm-support harnesses, rehabilitation support devices, wearable stabilization systems, or therapeutic mobility apparatuses.

A “non-track guided movement system” refers to a movement assistance arrangement configured to guide or support motion without requiring embedded rails, grooves, channels, tracks, or fixed mechanical pathways. Examples include magnetic floating movement systems, invisible magnetic guidance systems, trackless stabilization systems, or hover-guided mobility pathways.

A “cable-free stabilization system” refers to a stabilization or support arrangement operating substantially without suspended support cables, hanging lines, tensioned mechanical support members, or overhead tether systems. Examples include magnetic stabilization systems, invisible support systems, non-cable walking assist systems, or trackless magnetic support arrangements.

An “overhead support assembly” is any support structure positioned above a user and configured to provide guidance, stabilization, magnetic interaction, or movement assistance. Examples include ceiling Electro-Magnet Bars, overhead magnetic rails, ceiling-mounted support members, or elevated magnetic guidance systems.

A “magnetic propulsion/support field” refers to a magnetic field configured to exert directional force for support, attraction, stabilization, propulsion, positioning, or guided movement of one or more components or users. Examples include focused magnetic energy fields, cylindrical electromagnet fields, supportive attraction fields, or stabilization force fields.

A “user locomotion assistance system” refers to a system configured to assist, stabilize, rehabilitate, support, improve, or guide user walking, balance, ambulation, or general movement. Examples include walking stabilization systems, mobility assistance devices, rehabilitation movement supports, assisted ambulation systems, or guided walking apparatuses.

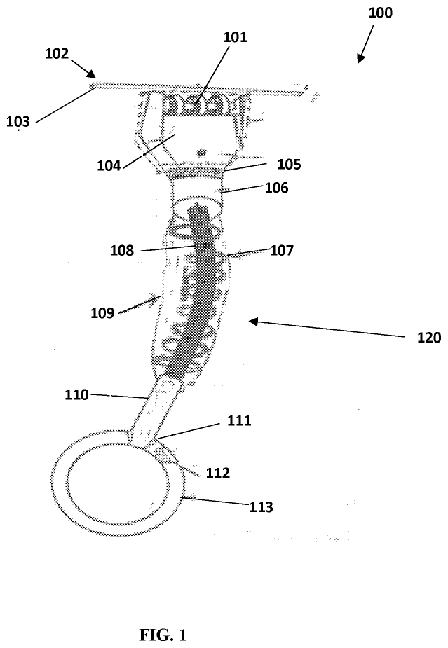

Various example embodiments of the present disclosure are described hereinafter with reference to FIG. 1 to FIG. 9. FIG. 1 illustrates a perspective view of a fall prevention support system 100 for assisted ambulation and stability enhancement, in accordance with an embodiment of the present disclosure. The fall prevention support system 100 includes an elongated magnetic support assembly 102 configured for attachment to a support structure, such as a ceiling, wall, or other architectural support structure, and a wearable lanyard assembly 120 configured to be worn or engaged by a user for magnetically assisted user movement and stabilization. The elongated magnetic support assembly 102 may include an overhead support assembly, including an electromagnet bar attached to a ceiling or wall. In some configurations, the elongated magnetic support assembly 102 may further include an embedded or concealed architectural magnetic pathway 103 positioned within a ceiling, wall, molding structure, or

### Architectural Enclosure.

The wearable lanyard assembly 120 includes a movement interface 101 configured to permit relative movement along the elongated magnetic support assembly 102 while maintaining a spaced relationship therebetween through magnetic attraction forces. The movement interface 101 may include wheels positioned on a lanyard cap configured to permit movement substantially without direct physical contact with the elongated magnetic support assembly 102. The wearable lanyard assembly 120 may further include a rolling carriage assembly 111 comprising a ball-bearing trolley lanyard configured for guided rolling movement adjacent the elongated magnetic support assembly 102. The wearable lanyard assembly 120 may additionally include a flexible rotational connector 108 comprising an interconnecting wire-rope configured to permit rotational, pivoting, twisting, angular, or multidirectional movement substantially approaching 360 degrees.

The fall prevention support system 100 further includes one or more magnetic interaction components, including a permanent magnetic element 104 comprising metallic, ceramic, rare-earth, composite magnetic materials, or combinations thereof. The magnetic interaction component may further include at least one cylindrical electromagnet 106 configured to generate a focused magnetic propulsion/support field for providing user support, stabilization, assisted guided movement, or combinations thereof. In some configurations, the magnetic interaction component may include a stacked magnetic array 107 comprising stacked round, interconnected, concentrically arranged, or serially arranged magnets configured to increase magnetic field strength and improve magnetic attraction forces between the elongated magnetic support assembly 102 and the wearable lanyard assembly 120. One or more magnetic interaction components may further be surrounded by a protective outer covering 109 configured to reduce the risk of user injury, impact damage, surface wear, or contamination.

The wearable lanyard assembly 120 may further include a portable power source 110, including a replaceable battery compartment configured to house one or more batteries for powering one or more magnetic interaction components associated with the fall prevention support system 100. The fall prevention support system 100 may additionally include an electrical power control switch 112 configured to selectively activate, interrupt, regulate, or control electrical power supplied to one or more magnetic interaction components, and a pressure-sensitive safety mechanism 105 configured to detect excess pulling force, hazardous tension, premature release conditions, overload conditions, or combinations thereof. The wearable lanyard assembly 120 may further include a hand engagement member 113 comprising a metal or plastic hand ring or a dual-hand stabilization member comprising an elongated handheld wand configured to provide support, stabilization, assisted ambulation, rehabilitation assistance, or movement control during user locomotion.

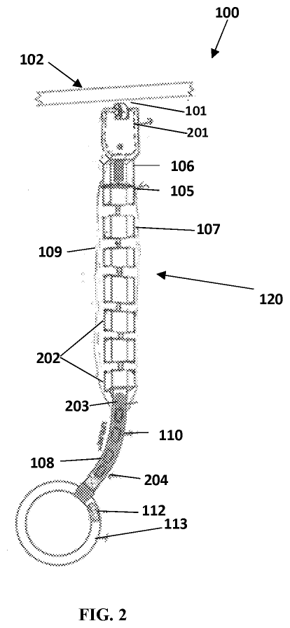

FIG. 2 illustrates a perspective view of a fall prevention support system 100 for assisted ambulation and stability enhancement, in accordance with another embodiment of the present disclosure. The fall prevention support system 100 includes the elongated magnetic support assembly 102 comprising a within-ceiling electromagnet bar configured to generate a magnetic propulsion/support field for assisted user movement and stabilization. The movement interface 101 maintains a spaced relationship between the elongated magnetic support assembly 102 and the wearable lanyard assembly 120 to permit guided relative movement substantially without direct physical contact.

The wearable lanyard assembly 120 further includes a lanyard sleeve cap cover 201 positioned adjacent the movement interface 101 and configured to partially enclose associated movement components of the wearable lanyard assembly 120. The wearable lanyard assembly 120 further includes the cylindrical electromagnet 106 configured to generate magnetic attraction forces relative to the elongated magnetic support assembly 102. The wearable lanyard assembly 120 may further include the pressure-sensitive safety mechanism 105 configured to detect excess pulling force, hazardous tension, abrupt release conditions, or combinations thereof.

The wearable lanyard assembly 120 further includes the protective outer covering 109 surrounding one or more magnetic interaction components and the stacked magnetic array 107 comprising interconnected magnetic elements configured to increase magnetic field strength. Floating magnetic interaction components 202 may be connected via the flexible rotational connector 108, which permits multidirectional movement approaching 360 degrees while maintaining magnetic coupling and assisted movement functionality. The wearable lanyard assembly 120 may further include a flexible woven lanyard material 203 configured to support assisted ambulation and user-assisted locomotion.

The wearable lanyard assembly 120 additionally includes a portable power source 110, including a replaceable battery compartment or a rechargeable battery 204, configured to supply electrical energy to one or more magnetic interaction components. The fall prevention support system 100 may further include the electrical power control switch 112 configured to selectively activate, interrupt, or regulate electrical energy supplied to the wearable lanyard assembly 120. The hand engagement member 113, comprising a metal or plastic hand ring, is configured to assist with user stabilization, movement control, rehabilitation, and guided ambulation during operation of the fall prevention support system 100.

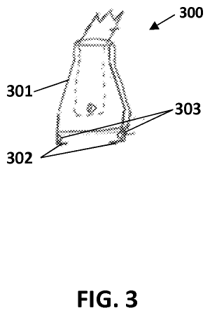

FIG. 3 illustrates a perspective view of a lanyard cap sleeve cover assembly 300 for use with the fall prevention support system 100 for assisted ambulation and stability enhancement, in accordance with an embodiment of the present disclosure. The lanyard cap sleeve cover assembly 300 includes a lanyard cap sleeve cover 301 configured to receive and secure an end portion of the wearable lanyard assembly 120. The lanyard cap sleeve cover 301 may further partially enclose one or more movement interface components associated with guided movement relative to the elongated magnetic support assembly 102.

The lanyard cap sleeve cover assembly 300 further includes one or more guide extensions 302 configured to engage corresponding guide rail structures associated with the elongated magnetic support assembly 102 to facilitate guided movement and alignment of the wearable lanyard assembly 120 during assisted ambulation and stabilization operation. The lanyard cap sleeve cover assembly 300 may additionally include one or more rolling carriage assembly components 303 comprising ball-bearing movement members configured to reduce friction and permit smooth guided movement relative to the elongated magnetic support assembly 102.

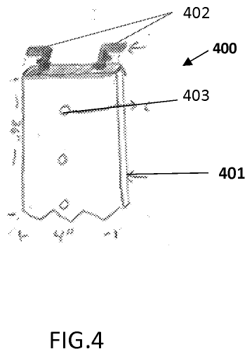

FIG. 4 illustrates a perspective view of an elongated magnetic support assembly 400 for use with the fall prevention support system 100 for assisted ambulation and stability enhancement, in accordance with an embodiment of the present disclosure. The elongated magnetic support assembly 400 includes a magnetic ceiling bar 401 configured to generate a magnetic propulsion/support field for guided movement assistance, stabilization, and assisted ambulation. The magnetic ceiling bar 401 may further be configured for attachment to a ceiling, wall, or other architectural support structure.

The elongated magnetic support assembly 400 further includes one or more guide rail structures 402 configured to receive and guide movement of a wearable lanyard assembly 120 or movement interface 101 during operation. The elongated magnetic support assembly 400 may additionally include one or more fastening openings 403 configured to receive fastening members for securing the elongated magnetic support assembly 400 to an architectural support structure.

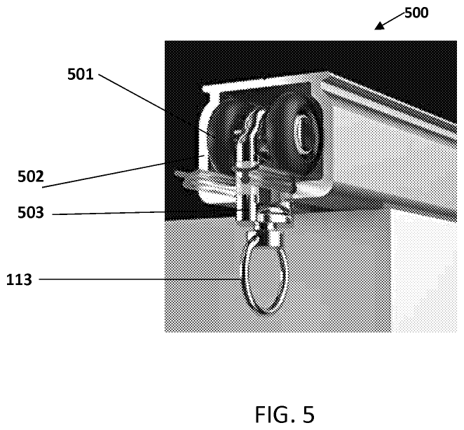

FIG. 5 illustrates a perspective view of a rolling carriage assembly 500 for use with the fall prevention support system 100 for assisted ambulation and stability enhancement, in accordance with an embodiment of the present disclosure. The rolling carriage assembly 500 includes one or more ball-bearing movement members 501 configured to facilitate guided rolling movement relative to a guide structure while reducing friction during assisted ambulation and stabilization operation.

The rolling carriage assembly 500 further includes a guide channel structure 502 configured to receive and retain one or more ball-bearing movement members 501 during movement relative to the elongated magnetic support assembly 102. The rolling carriage assembly 500 may additionally include a support coupling member 503 configured to mechanically connect the rolling carriage assembly 500 to a wearable lanyard assembly 120. The hand engagement member 113 may further extend from the support coupling member 503 to permit user engagement, stabilization, assisted ambulation, and movement control.

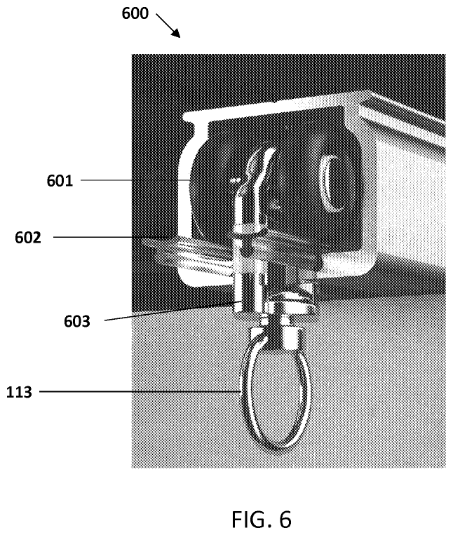

FIG. 6 illustrates a perspective view of a heavy-duty rolling carriage assembly 600 for use with the fall prevention support system 100 for assisted ambulation and stability enhancement, in accordance with an embodiment of the present disclosure. The heavy-duty rolling carriage assembly 600 includes one or more heavy-duty ball-bearing movement members 601 configured to support increased loading forces during assisted ambulation, rehabilitation assistance, stabilization, or fall-prevention operations.

The heavy-duty rolling carriage assembly 600 further includes a guide channel structure 602 configured to receive and retain one or more heavy-duty ball-bearing movement members 601 during guided movement relative to an elongated magnetic support assembly 102. The heavy-duty rolling carriage assembly 600 may additionally include a support coupling member 603 configured to mechanically connect the heavy-duty rolling carriage assembly 600 to a wearable lanyard assembly 120. The hand engagement member 113 may further extend from the support coupling member 603 to permit user engagement, stabilization, assisted ambulation, rehabilitation assistance, and movement control.

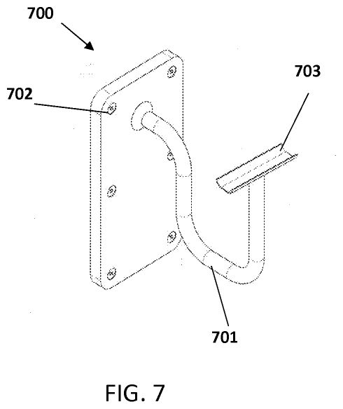

FIG. 7 illustrates a perspective view of a support mounting assembly 700 for use with the fall prevention support system 100 for assisted ambulation and stability enhancement, in accordance with an embodiment of the present disclosure. The support mounting assembly 700 includes a support engagement member 701 comprising a curved J-hook structure configured to support a cable, rope, guide wire, or guided mobility pathway associated with assisted ambulation and stabilization operation.

The support mounting assembly 700 further includes one or more fastening members 702 configured to secure the support mounting assembly 700 to a ceiling, wall, or other architectural support structure. The support engagement member 701 may further define a trolley passage region 703 configured to permit the guided movement of the rolling carriage assembly 111, the movement interface 101, or the wearable lanyard assembly 120 relative to the support engagement member 701.

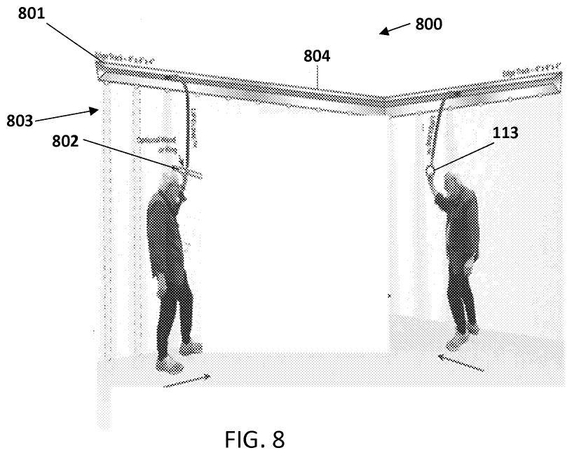

FIG. 8 illustrates a perspective view of an edge-track support assembly 800 for use with the fall prevention support system 100 for assisted ambulation and stability enhancement, in accordance with an embodiment of the present disclosure. The edge-track support assembly 800 includes one or more guided mobility pathways 801 extending along an architectural edge region between a ceiling structure and one or more wall structures to facilitate assisted ambulation and guided movement operation.

The edge-track support assembly 800 further includes one or more wearable lanyard assemblies 120 suspended from the guided mobility pathways 801 and configured for user stabilization, rehabilitation assistance, movement control, and assisted ambulation. The wearable lanyard assemblies 120 may further include hand engagement members 113 and/or dual-hand stabilization members 802 configured for guided user support and stabilization.

The edge-track support assembly 800 may additionally include one or more illumination assemblies 803 configured to direct illumination toward a floor pathway or walking surface during operation. The illumination assemblies 803 may include automatic down-lighting structures configured to activate in response to movement of the wearable lanyard assemblies 120 along the guided mobility pathways 801.

The edge-track support assembly 800 may further include one or more recessed installation regions 804 configured for partial or complete positioning of the edge-track support assembly 800 within the architectural edge region between the ceiling structure and wall structures. The edge-track support assembly 800 may be configured for installation in residential structures, rehabilitation environments, medical facilities, assisted living environments, or other environments for user locomotion assistance.

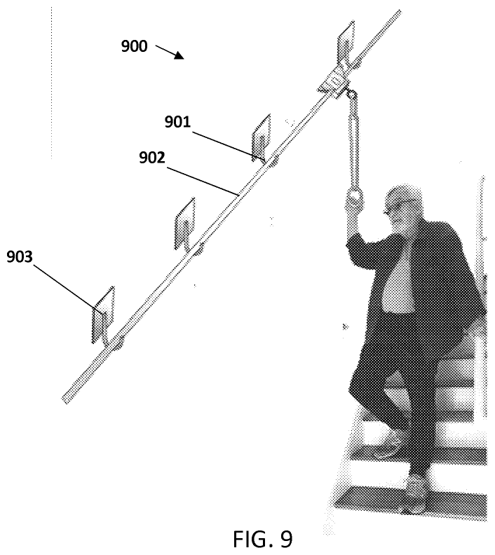

FIG. 9 illustrates a perspective view of a stairway guided mobility pathway assembly 900 for use with the fall prevention support system 100 for assisted ambulation and stability enhancement, in accordance with an embodiment of the present disclosure. The stairway guided mobility pathway assembly 900 includes one or more support engagement members 901 comprising J-hook structures configured to support a movement pathway member 902 extending along a stairway region.

The movement pathway member 902 may include a wire rope, marine rope, cable structure, or guided support line configured to provide guided movement assistance during stair traversal. The rolling carriage assembly 111 may be movably coupled to the movement pathway member 902 and configured to support guided relative movement of the wearable lanyard assembly 120 during assisted ambulation and stabilization operation.

The stairway-guided mobility pathway assembly 900 may further include one or more fastening members 903 configured to secure the support engagement members 901 to a wall, ceiling, stairway structure, or other architectural support structure. The wearable lanyard assembly 120 may further include the hand engagement member 113 configured to assist user stabilization, movement control, rehabilitation assistance, and guided ambulation while traversing the stairway region.

The present disclosure provides an overhead-supported mobility assistance arrangement configured to provide continuous stabilization and guided ambulation through magnetic interaction between an elongated magnetic support assembly and a wearable lanyard assembly. Unlike conventional grab bars, walkers, rails, or suspended support systems that rely primarily on direct physical engagement or floor-supported structures, the disclosed system utilizes magnetic attraction forces to maintain user support and guided movement while permitting relative movement along a defined mobility pathway. The disclosed arrangement further permits contactless or substantially contactless movement assistance via movement interfaces, rolling carriage assemblies, and magnetic interaction components, thereby reducing friction, minimizing mechanical obstruction, and improving assisted ambulation within residential, rehabilitation, medical, and institutional environments.

The present disclosure further provides integrated architectural mobility assistance configurations including concealed or embedded elongated magnetic support assemblies, edge-track support assemblies, stairway guided mobility pathway assemblies, and removable support mounting arrangements configured to facilitate assisted movement across multiple architectural regions. The combination of wearable lanyard assemblies, cylindrical electromagnets, stacked magnetic arrays, flexible rotational connectors permitting multidirectional movement, pressure-sensitive safety mechanisms, and portable power sources enables adaptive stabilization and guided movement assistance while maintaining user mobility and accessibility. The disclosed arrangements further provide continuous assisted ambulation support without requiring permanent floor-mounted tracks, visible suspended cable systems, or continuous direct mechanical attachment between interacting components.

Various embodiments of the disclosure, as discussed above, may be practiced with steps and/or operations in a different order, and/or with hardware elements in configurations that are different from those which are disclosed. Therefore, although the disclosure has been described based upon these exemplary embodiments, it is noted that certain modifications, variations, and alternative constructions may be apparent and well within the scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. An assistive mobility and stabilization system comprising:
an elongated magnetic support assembly configured for attachment to a support structure;
at least one wearable lanyard assembly configured to be engaged by a user; wherein the elongated magnetic support assembly and the at least one wearable lanyard assembly are magnetically coupled to generate a magnetic attraction force sufficient to provide user support, stabilization, guided movement assistance, fall-resistance assistance, or any combination thereof during user ambulation;
at least one magnetic interaction component associated with at least one of the elongated magnetic support assembly or the at least one wearable lanyard assembly; and
a movement interface configured to permit relative movement of the at least one wearable lanyard assembly along the elongated magnetic support assembly while minimizing direct physical contact therebetween.

2. The system of claim 1, wherein the at least one wearable lanyard assembly includes one or more wheels configured to permit relative movement along the elongated magnetic support assembly while maintaining a spaced relationship from the elongated magnetic support assembly through magnetic attraction forces.

3. The system of claim 1, wherein the elongated magnetic support assembly is mounted to a support structure, the support structure including a ceiling, a wall, or an internal architectural structure.

4. The system of claim 1, wherein the elongated magnetic support assembly is embedded within, partially concealed within, or concealed by a ceiling, wall, molding structure, or architectural enclosure.

5. The system of claim 1, wherein the at least one magnetic interaction component includes one or more permanent magnets comprising metallic, ceramic, rare-earth, composite magnetic materials, or combinations thereof.

6. The system of claim 1, further comprising a pressure-sensitive safety switch configured to reduce, interrupt, release, or otherwise modify magnetic force upon detection of excess pulling force, hazardous tension, premature release conditions, or combinations thereof.

7. The system of claim 1, wherein the elongated magnetic support assembly or the at least one wearable lanyard assembly includes at least one cylindrical electromagnet configured to generate focused magnetic energy.

8. The system of claim 1, wherein multiple magnets are stacked, interconnected, concentrically arranged, or serially arranged to increase magnetic field strength.

9. The system of claim 1, wherein the at least one wearable lanyard assembly includes a flexible interconnecting wire-rope configured to permit rotational movement substantially approaching 360 degrees.

10. The system of claim 1, wherein at least one magnetic component is surrounded by a soft protective covering configured to reduce user injury, impact damage, surface wear, or combinations thereof.

11. The system of claim 1, wherein the at least one wearable lanyard assembly further comprises a battery compartment configured to house one or more replaceable or rechargeable batteries for powering one or more magnetic components.

12. The system of claim 1, wherein the at least one wearable lanyard assembly includes a ball-bearing trolley configured for rolling movement adjacent the elongated magnetic support assembly.

13. The system of claim 1, further comprising an on/off switch configured to selectively control electrical energy supplied to one or more magnetic components.

14. The system of claim 1, wherein the at least one wearable lanyard assembly further comprises a hand ring, a dual-hand gripping wand, or another handheld engagement structure configured for user stabilization, support, or movement control.

15. The system of claim 1, wherein the elongated magnetic support assembly defines an invisible mobility pathway configured to permit guided user movement without visible rails, suspended cables, or floor-mounted tracks.

16. The system of claim 1, wherein magnetic field intensity is adjustable in response to user movement, instability, fatigue, rehabilitation conditions, fall conditions, or combinations thereof.

17. The system of claim 1, wherein the elongated magnetic support assembly extends continuously through multiple rooms, hallways, or structural regions to provide uninterrupted assisted mobility.

18. The system of claim 1, wherein the at least one wearable lanyard assembly is guided substantially without direct mechanical attachment to the elongated magnetic support assembly.

19. An assistive mobility and stabilization system comprising:
an elongated magnetic support assembly extending along a user movement pathway;
a wearable magnetic lanyard assembly configured to be engaged by a user,
wherein the elongated magnetic support assembly and the wearable magnetic lanyard assembly are magnetically coupled to generate a magnetic attraction force configured to assist user stabilization, guided movement, ambulation support, or fall-resistance during movement; and
a movement interface configured to permit guided movement of the wearable magnetic lanyard assembly along the elongated magnetic support assembly while maintaining a spaced relationship therebetween.

20. A fall-prevention mobility assistance system comprising:
an elongated support structure configured for installation within or adjacent to a ceiling, wall, or architectural structure;
at least one magnetic guidance assembly extending along the elongated support structure; and
at least one user-engageable lanyard assembly magnetically interacting with the magnetic guidance assembly to provide assisted movement and stabilization to a user moving through an environment.
